(19) United States
(12) Patent Application Publication
(10) Pub. No.: US 2004/0089154 A1
(43) Pub. Date: May 13, 2004

(54) Inline air filter

(76) Inventors: Hung T. Le, St. Louis, MO (US); Hieu T. Le, St. Louis, MO (US); Tung T. Le, St. Louis, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/608,836

(22) Filed: Jun. 27, 2003

Related U.S. Application Data
(60) Provisional application No. 60/393,483, filed on Jul. 3, 2002.

(51) Int. Cl. B01D 46/00

(52) U.S. Cl. 95/287; 55/485; 55/502; 55/503; 55/511

(57) ABSTRACT

An inline air filter for fuel injected engines that provides for the installation of the air filter into the air intake line of an air intake system of a fuel injected engine. The inline air includes a foam filter, a foam filter mesh, and a mesh filter. The foam filter is made from a flexible reticulated polyurethane foam material that allows proper air flow while maintaining good filtering capability. The inline air filter is installed onto an air intake assembly of the fuel injected engine by splicing the inline air filter into an air intake tube.

### CROSS-REFERENCE TO RELATED APPLICATIONS

This application is related to U.S. Provisional Patent Application 60/393,483 filed Jul. 3, 2002 from which priority is claimed.

### STATEMENT REGARDING FEDERALLY SPONSORED RESEARCH OR DEVELOPMENT

Not applicable.

### BACKGROUND OF THE INVENTION

1. Field of the Invention

All gasoline engines are essentially pumps that draw air and fuel into the internal portion of the engine, and then discharge the remnants of the combustion process that occurs within the cylinders of the engine. While the fuel is usually drawn from a fuel tank dedicated to the engine, the air is normally ambient air drawn from the atmosphere surrounding the engine. This ambient air can be relatively clean or it can be filled with a number of various contaminants ranging from small particles like mold spore and plant pollen, to larger particles such as dust, leaves, and other road debris.

The presence of such contaminants within the ambient air drawn into the engine requires filtration of the air brought into the engine cylinders for internal combustion. A failure to filter the air properly will result in damage to the internal components of the engine.

However, the air filtration process introduces hot air and restrictions into the engine air intake system that robs the engine of usable horsepower. The horsepower output of any gasoline engine is very dependant upon the amount of air and fuel that can be drawn into the engine while the engine is operating. Cooler air is more oxygenated than warmer air making cooler air more desirable for internal combustion engines. A restriction in the flow rate of either the fuel or the intake air can also directly result in the loss of available horsepower from the engine. Therefore, there is a recognized need to provide proper filtration of the air drawn into an engine while still allowing the maximum volume of cooler to pass into the engine cylinders for combustion.

Many devices have been designed to provide filtration of engine air. Most of these devices consist of simple housings which contain a single filtration element. In the case of naturally aspirated gasoline engines equipped with carburetors, the housing is normally configured to rest upon the top of the intake portion of the carburetor. The situation is different for fuel injected engines. The general configuration of fuel injected engines includes an intake manifold that ports the air fuel mixture to the individual engine cylinders. Each cylinder usually has its own dedicated fuel injector that introduces fuel to the engine cylinder and the fuel injector is normally located on or near the air intake manifold. Prior to passing into the intake manifold and the engine cylinders, there is a throttle body that contains at least one butterfly valve that controls the amount of air that passes into the air intake manifold and into the engine cylinders. Ahead of the throttle body is an air intake system that usually contains an air metering devices that works to coordinate the fuel and air mixture being provided to the engine cylinders. The air intake system usually terminates in an air filtration device mounted to the end of an air intake tube. It is this air intake device that forms the technical field of the present invention.

2. Description of Related Art

Within the field of engine filtration devices, there are a number of inventions that have been designed to provide air filtration for engines. While these devices provide filtration to engines, each of them may result in the introduction of warm air into the engine and usually introduce substantial restrictions of the air being drawn in to the engine.

U.S. Pat. No. 6,258,144 issued to Huang is an air filtration device that includes two cone-shaped filtering members that are coaxially mounted within a housing, and also includes a ring with blades that generates a spiral flow of air to the engine. The primary purpose of the invention is to change the flow of the air into the air intake system from a turbulent state to a more controlled spiraling state as the air passes through the air intake tubing. In accomplishing this goal, however, the volume of air is strictly dependent upon the air porosity of the filtration element. When the air filtration element is covered with a layer of restrictive debris, the ability of the element to allow passage of air into the engine is severely compromised.

In U.S. Pat. No. 5,858,044 issued to Nespund et al., provides an alternative filtering device. That invention includes a combination of two types of filtering elements. The first element acts as a pre-filter to prevent the entry of large contaminants into the engine. The second filtering element is made from foam and is intended to prevent the entry of smaller contaminants into the engine. Although the filter may provide good filtration of the intake air, the result of this double filtering can be the collection of two layers of debris through which the intake air must pass before being able to enter the engine.

A number of other similar air filtering devices with similar drawbacks are disclosed in other patents such as U.S. Pat. Nos. 6,261,333 issued to Dickson, 4,235,611 issued to Brownell, 4,197,101 issued to Cote, et al, 5,562,746 issued to Raether, and 5,368,621 issued to Pool. While each of these devices provides an air filtration system for an engine, each of them does so with the disadvantage of creating a barrier that can severely reduce the flow of intake air to an engine, and none of these devices provides an air filtering device that can be spliced into the tubing of an air intake system and that will provide a good flow of cooler air at various engine rotation rates.

### SUMMARY OF THE INVENTION

This patent application relates to air filters in general, and specifically, to an air filter capable of being installed inline with an existing air intake system of a fuel injected engine. The present invention contains a unique combination of filters and screens that acts to improve the performance of the air filtering system of the engine by controlling the incoming air at various engine RPM's.

Other objects and features of the present invention will be in part apparent and in part pointed out hereinafter.

### DESCRIPTION OF THE DRAWINGS

FIG. 1 is a front perspective view of one embodiment of the present invention.

FIG. 2 is a front view of one embodiment of the present invention.

FIG. 3 is a side view of one embodiment of the present invention.

FIG. 4 is an exploded view of one embodiment of the present invention showing the arrangement of the various components of the invention.

Corresponding reference characters indicate corresponding parts throughout the several views of the drawings.

### DETAILED DESCRIPTION OF THE INVENTION

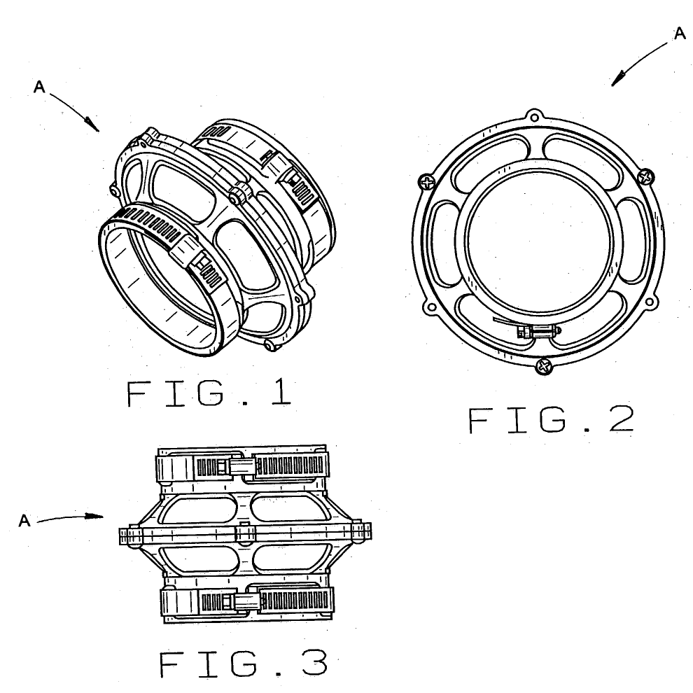

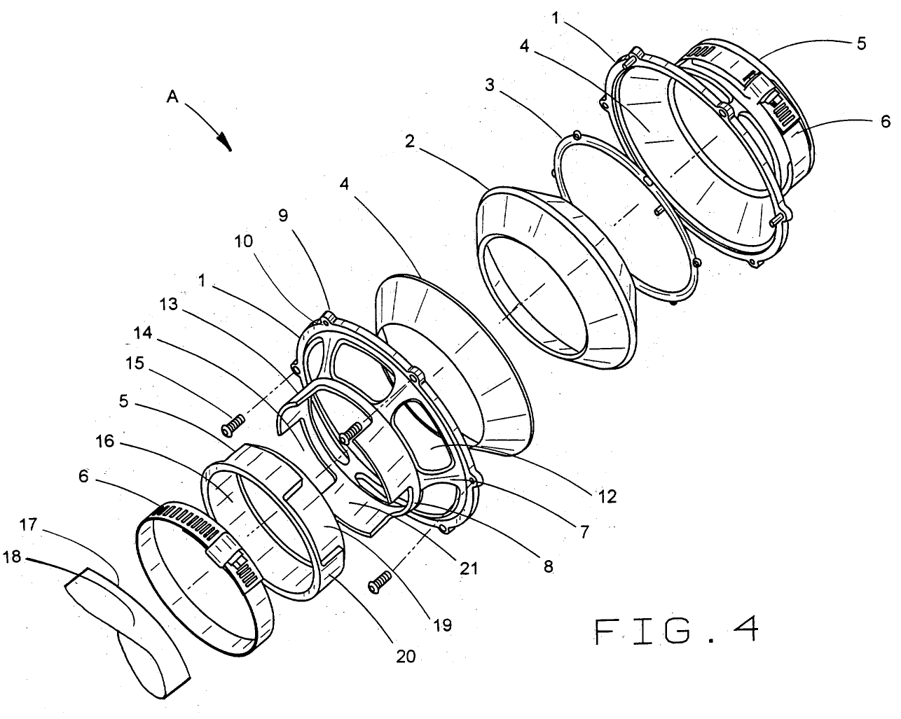

FIG. 1 shows one embodiment of the present invention of an inline air filter A. FIGS. 2 and 3 show a perspective view, a side view, and a top view of the current embodiment of the present invention. FIG. 4 shows an exploded view of the inline air filter A and displays the arrangement of the components of the inline air filter A. The inline air filter A includes two housings 1, a foam filter 2, two mesh filters 4, two housing grommets 5, and two clamps 6. Each of the two housings 1 has a plurality of protrusions 9 with each protrusion having a fastener opening 10. In the present embodiment, the fastener openings are configured such that one set of fastener openings in one of the two housings 1 has a clearance hole for the fasteners 15, while the other housing 1 has threaded holes to match the fasteners 15. It will be understood by those skilled in the art that other types of fasteners may be used while still remaining with the scope of the present invention.

While the two housings 1 of the present embodiment are made from metallic material, other materials may be used so long as they are able to function within the environment of an automobile engine bay.

Each of the two housings 1 also includes a generally cone-shaped portion 7 and a generally cylindrical portion 8. In the present embodiment, the generally cone-shaped portion 7 has a plurality of generally elliptical openings 12 located in a radial pattern around the cone shaped portion 7. In other embodiments, the cone-shaped portion 7 will have at least one opening rather than a plurality of openings. It will also be appreciated that while the present embodiment discloses a generally cone-shape portion 7, this area of the housing 1 may be of any shape as long as the final shape of the housing 1 permits the installation of the foam filter 2 and allows for the entrance of outside air into the interior of the inline air filter A. The generally cylindrical portion 8 comprises a plurality of alternating curved flanges 13 and curved openings 14.

The housing grommets 5 are generally ring shaped and are configured to fit within the opening of the generally cylindrical shaped portion 8 of the main housings 1. The housing grommets 5 have in inside circumferential surface 16 that is sized to fit the outside diameter 18 of the air intake tubing 17 that exists on the air intake system of a gasoline engine (not shown). It is understood that the actual size of the inside diameter of the inside circumferential surface 16 will be determined by the size of the air intake tubing 17 of the particular air intake system upon which the inline air filter A will be mounted. This diameter, however, should be such that when the inline air filter A is installed, the entrance of air between the inside circumferential surface 16 and the outside surface 18 of the air intake tubing 17 is minimized.

The housing grommets 5 have a plurality of indented surfaces 19 on their outer circumferential surface 20. The plurality of indented surfaces 20 are located and shaped to match the location and shape of the plurality of alternating curve flanges 13 and curved openings 14 in the housings 1. The radial depth of the plurality of indented surfaces 19 in the housing grommets 5 is such that the housings 1 can be installed over the housing grommets 5 such that there is a slight interference fit between the inner surfaces 21 of the curved flanges 13 of the housings 1 and the plurality of indented surfaces 19. The slight interference fit results in a tight fit between the inside circumferential surface 16 and the outside surface 18 of the air intake tubing 17 after the housing grommets 5 and the housings 1 have been installed over the air intake tubing 17, and the clamps 6 have been positioned and tightened over the housing grommets 5.

In the embodiment described herein, the foam filter 2 is made from flexible reticulated polyurethane foam material. This washable material has a unique three dimensional cellular structure that captures debris without a rapid loss in air flow through the foam filter. This foam material is operable within the temperature range of from about +225 degrees Fahrenheit to about −40 degrees Fahrenheit. While flexible reticulated polyurethane foam is used in the present embodiment, it will be appreciated that other types of materials may be used in other embodiments so long as adequate air flow through the foam filter is maintained. The foam filter 2 is a shaped to match the mesh filter 4 and the generally cone shaped portion 7 of the housings 1. A foam filter support 3 is placed within the foam filter 2 to retain the foam filter 2 in position within the inline air filter A.

The mesh filter 4 is made from a metallic screen material made from wire of about 0.15 inches thick. The mesh filter 4 is sized and shaped to match the generally cone shaped portion 7 of the housings 1.

In its assembled form, the present embodiment of the inline air filter A includes the two housings 1, the foam filter 2, a foam filter support 3, and the two mesh filters 4 assembled as a single unit. It will be appreciated that in other embodiments of the present invention, the foam filter support can be eliminated and the foam filter 2 is instead affixed to the two mesh filters 4. The method of affixation may be small dots of glue that hold the foam filter 2 to the two mesh filters 4, or any other method so long as the foam filter 2 does not separate from the two mesh filters 4 during operation and the method of attachment does not significantly interfere with the air flow through the inline filter A. While the housing grommets 5 and the clamps 6 may also be installed onto the main housings 1 for storage or shipment, the housing grommets 5 and the clamps 6 must be removed from the housings 1 for installation of the inline air filter A.

Installation of the inline filter A is accomplished by splicing it into the air intake tubing 17 of an engine's air induction system. First, a portion of the existing air intake tubing 17 is cut from the air intake piping of the engine. The length of air intake tubing 17 removed is determined by the length of the inline air filter A as used in the specific application. After the air intake tubing 17 has been cut, a clamp 6 and a housing grommet 5 are placed onto each of the two cut ends of the air intake tubing by slipping those parts over the outside of the air intake tube 17. The housing 1 is positioned in the gap between the to two cut ends of the air intake tubing 17 and each of the two housings 1 is slipped over the housing grommet 5. The clamps 9 are then positioned over the generally cylindrical portion 8 of each of the housings 1 such that the clamps 6 squeeze the housing grommets 5 and the housings 1 against the outside surface of the air intake tube 17. The clamps 6 are then tightened to secure the inline air filter A to the air intake tube 12.

When fully assembled and installed the present embodiment of the inline air filter A has a flow rate of at least about 227 cubic feet per minute and is capable of filtering out debris having a size of at least about 25 microns or larger.

The unique combination of filters and screens as described above has been shown to improve the performance of the air filter system by efficiently providing and controlling cool incoming air at different RPM ranges thus optimizing performance.

While the above description describes various embodiments of the present invention, it will be clear that the present invention may be otherwise easily adapted to fit any configuration where an inline air filter A may be utilized.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

What I claim is:

1. An inline air filter for use in the air intake systems of fuel injected engines comprising:
two housings;
a foam filter;
two mesh filters;
two housing grommets; and
two clamps.

2. The inline air filter of claim 1 wherein each of the two housings have a plurality of protrusions with each protrusion having a fastener opening.

3. The inline air filter of claim 2 wherein the foam filter, the two mesh filters are installed between the two housings and the two housings are installed together with a set of fasteners.

4. The inline air filter of claim 3 wherein the fastener opening in the plurality of protrusions are configured such that one set of fastener openings in one of the two housings has a clearance hole for the fasteners, while the other of the two housings has threaded holes to match the fasteners, and wherein the set of fasteners used to install the two housings together are one of either threaded screws of threaded bolts.

5. The inline air filter of claim 4 wherein the two housings are made from a metallic material.

6. The inline air filter of claim 5 wherein the each of the two housings includes a generally cone-shaped portion and a generally cylindrical portion.

7. The inline air filter of claim 6 wherein each of the two housings has at least one air flow opening located in the cone shaped portion.

8. The inline air filter of claim 7 wherein the generally cylindrical portion of each of the two housings comprises a plurality of alternating curved flanges and curved openings.

9. The inline air filter of claim 8 wherein the two housing grommets are generally ring shaped and are configured to fit within the opening of the generally cylindrical shaped portion of the two housings.

10. The inline air filter of claim 9 wherein the two housing grommets have an inside circumferential surface having an inside diameter sized to fit an outside diameter of an air intake tubing of a gasoline engine, the inside diameter, being sized such that when the inline filter is installed, entrance of air between the inside circumferential surface and an outside surface of the air intake tubing is minimized.

11. The inline air filter of claim 10 wherein each of the two housing grommets has a plurality of indented surfaces on its outer circumferential surface.

12. The inline air filter of claim 11 wherein the plurality of indented surfaces are located and shaped to match the location and shape of the plurality of alternating curved flanges and curved openings in the main housing.

13. The inline air filter of claim 12 wherein the radial depth of the plurality of indented surfaces in each of the two housing grommets is such that each of the two housings can be installed over the housing grommet such that there is a slight interference fit between inner surfaces of the curved flanges of the housings and the plurality of indented surfaces, the slight interference fit resulting in a snug fit between the inside circumferential surface and the outside surface of the air intake tubing after the two housing grommets and the two housings have been installed over the air intake tubing and each of the clamps has been positioned and tightened over each of the housing grommets.

14. The inline air filter of claim 13 wherein the foam filter is made from a flexible reticulated polyurethane foam material.

15. The inline air filter of claim 14 wherein the foam material is washable, has a three dimensional cellular structure and is operable within the temperature range of from about +225 degrees Fahrenheit to about −40 degrees Fahrenheit.

16. The inline air filter of claim 15 wherein the mesh filter is made from a metallic screen material having a wire about 0.015 inches thick.

17. The inline air filter of claim 16 further comprising a foam filter support.

18. The inline air filter of claim 17 wherein an installation of the inline air filter includes splicing the inline air filter into the air intake tubing of an air induction system of a fuel injected engine.

19. The inline air filter of claim 18 wherein the inline air filter has an air flow rate of at least 227 cubic feet per minute.

20. The inline air filter of claim 19 wherein the inline air filter filters out debris having a size of at least 25 microns.

21. A process of using a inline air filter for filtering air in conjunction with an air intake system of an internal combustion engine comprising the steps of:
providing a foam filter;
providing a mesh filter;
providing a main housing, the main housing comprising two housings, two housing grommets; and two clamps;
assembling the foam filter and the mesh filter onto the housing to make an inline air filter; and
installing the inline air filter onto a component of an air intake system of a fuel injected engine.

22. The process of claim 21 further comprising the step of making the foam from a three dimensional cellular structure and is operable within the temperature range of from about +225 degrees Fahrenheit to about −40 degrees Fahrenheit.

23. The process of claim 22 further comprising the step of making the mesh filter from a metallic screen material having a wire about 0.015 inches thick.

24. The process of claim 23 wherein the step of installing the inline air filter onto a component of an air intake system of a fuel injected engine includes splicing the inline air filter into an air intake assembly for an air induction system of a fuel injected engine.

25. The process of claim 24 wherein the assembled inline air filter has an air flow rate of at least 227 cubic feet per minute and wherein the assembled inline air filter filters out debris having a size of at least 25 microns.
